(19) United States
(12) Patent Application Publication
(10) Pub. No.: US 2008/0239038 A1
(43) Pub. Date: Oct. 2, 2008

(54) LIQUID STORAGE CONTAINER AND LIQUID STORAGE BODY-RECEIVING MAMBER

(75) Inventors: Tadayuki YOSHIMOTO, Matsumoto-shi (JP); Kazuo KOSHINO, Azumino-shi (JP)

Correspondence Address: SUGHRUE MION, PLLC, 2100 Pennsylvania Avenue, N.W., Washington, DC, 20037, US

(73) Assignee: SEIKO EPSON CORPORATION, Tokyo (JP)

(21) Appl. No.: 12/058,592

(22) Filed: Mar. 28, 2008

(30) Foreign Application Priority Data
Mar. 28, 2007 (JP) 2007-083698

(51) Int. Cl. B41J 2/175

(52) U.S. Cl. 347/86

(57) ABSTRACT

A liquid storage container is provided which is configured to be detachable from a liquid ejecting apparatus. The storage container includes a liquid storage body having a liquid storage portion for storing liquid therein, a liquid storage body-receiving member configured as a separate body from the liquid storage body and detachably receiving the liquid storage body, and a detection sensor provided to the liquid storage body-receiving member and used in detecting the liquid within the liquid storage body.

### BACKGROUND

1. Technical Field

The present invention relates to a liquid storage container that stores liquid, and to a liquid storage body-receiving member that constitutes part of the liquid storage container.

2. Related Art

A liquid ejecting apparatus forms predetermined characters, figures or images (hereinafter, collectively referred to as “images”) on a printing sheet, a glass substrate, or a resin substrate. In a liquid ejecting apparatus, liquid stored in a liquid storage container is ejected from an ejecting head onto a medium to form predetermined images on the medium (the medium may be thought of more generally as an ejection subject). One example of such a liquid ejecting apparatus ejects ink, as the liquid, onto a printing sheet, as the ejection subject, to form predetermined images on the printing sheet.

Ink jet printers of this type are configured such that ink is supplied to an ejecting head from an ink cartridge, serving as a liquid storage container in which ink serving as the liquid is stored in advance, and the ink is ejected in a controlled manner thereby printing predetermined images on the printing sheet. To stably print images on the printing sheet, it is necessary to manage the ink cartridge so that the ink supply is not interrupted during printing. There are known technologies for detecting the ink consumption state within the ink cartridge so as to ensure that the ink supply is not interrupted.

One example of such a detection technology is described in JP-A-2001-328280. More particularly, this document discloses a technology in which a piezoelectric device is used as a detection sensor. The piezoelectric device detects the consumption state of ink within an ink cartridge. The piezoelectric device is detachably attached to the ink cartridge, which has ink stored therein. This approach to detection technology provides for a highly accurate detection of the ink consumption state. Since the piezoelectric device is detachably attached to the ink cartridge, the device can be separated from the ink cartridge when the cartridge is replaced. Accordingly, the separated piezoelectric device can be reused.

However, the approach disclosed in JP-A-2001-328280 is to perform detection of the ink in the cartridge with the piezoelectric device abutting the ink stored in the ink cartridge. Therefore, it is necessary for the ink cartridge to have a structure such that, when the piezoelectric device is attached to the ink cartridge, ink does not leak out from where the piezoelectric device attaches to the ink cartridge. It is also important that the piezoelectric device not be easily detached from the ink cartridge. In view of these points, although the piezoelectric device is in fact detachably attached to the ink cartridge, it is necessarily hard to detach the piezoelectric device from the ink cartridge.

Another key point to keep in mind about the approach in the foregoing document is that the ink storage container meant to receive such a piezoelectric device must have an opening into which the device is to be attached. Because of the opening, the cartridge cannot have ink in it prior to the attachment of the piezoelectric device because the ink would undesirably come out of the opening. As a result, when the piezoelectric device is reused, it is necessary to attach the piezoelectric device to the next ink cartridge before the cartridge is filled with ink.

In the light of these points, it will be appreciated that the approach taken in the JP-A-2001-328280 document cannot be said that to increase production efficiency. That is to say, it is practically impossible to attach the piezoelectric device to the ink cartridge after ink is in the cartridge, and the ink cartridge cannot be sold in an ink-full state if users are themselves to attach the piezoelectric device to the ink cartridge. Therefore, it is necessary to sell each ink cartridge with the piezoelectric device already attached thereto. As a result, it is difficult to reduce the cost of the ink cartridge and it is thus less desirable to the users.

### SUMMARY

An advantage of some aspects of the invention is that it provides a liquid storage container capable of detecting the consumption state of the ink within the liquid storage container storing ink therein and configured such that a detection sensor is attached or detached to and from the ink cartridge with ease while preventing the leakage of ink from the liquid storage container filled with ink.

According to an aspect of the invention, there is provided a liquid storage container configured to be detachable from a liquid ejecting apparatus, the storage container including: a liquid storage body having a liquid storage portion for storing liquid therein; a liquid storage body-receiving member configured as a body separate from the liquid storage body and detachably receiving the liquid storage body; and a detection sensor provided to the liquid storage body-receiving member and used in detecting the liquid within the liquid storage body.

According to the configuration, when the liquid storage body is attached to the liquid storage body-receiving member, the liquid in the liquid storage portion is detected by the detection sensor provided to the liquid storage body-receiving member. Therefore, it is possible to detect the liquid consumption state without needing to provide the detection sensor to the liquid storage body. Since the detection sensor is provided to the liquid storage body-receiving member instead of to the liquid storage body itself, it is possible to detach the detection sensor from the liquid storage container by detaching the liquid storage body-receiving member from the liquid storage body. Even when the liquid storage portion is filled with liquid, the liquid does not leak from the liquid storage body. Therefore, it is possible to attach the detection sensor even when liquid storage body is filled with liquid.

A detecting portion having a characteristic that varies with the amount of the liquid within the liquid storage body may be formed in the liquid storage body. The detection sensor may be capable of detecting a change in the characteristic of the detecting portion. By doing this, the amount of liquid in the liquid storage portion is detected by the detecting portion formed in the liquid storage portion. Therefore, it is possible to determine the amount of liquid within the liquid storage portion, that is, the liquid consumption state, while preventing the liquid in the liquid storage portion from flowing out from the liquid storage portion.

Here, the characteristic may be a vibration frequency. It is generally known that when a vibration plate freely vibrates, the vibration frequency when is in contact with a liquid differs from the vibration frequency when it is in contact with air. Therefore, by forming the vibration plate serving as the detecting portion such that the vibration frequency of the vibration plate varies with the amount of liquid in the liquid storage portion, it is possible to determine the amount of liquid within the liquid storage portion, that is, the liquid consumption state by the change in the vibration frequency of the vibration plate.

Alternatively, the characteristic may be a vibration amplitude of a vibration plate. It is generally known that when a vibration plate freely vibrates, the vibration amplitude differs from a case where the vibration plate is in contact with liquid to a case where it is in contact with air. Therefore, by forming the vibration plate serving as the detecting portion such that the vibration amplitude of the vibration plate varies with the amount of liquid in the liquid storage portion, it is possible to determine the amount of liquid within the liquid storage portion, that is, the liquid consumption state by the change in the vibration amplitude of the vibration plate.

The detection sensor may be formed using a piezoelectric device. The piezoelectric device has an electrostriction effect in that it generates an electric voltage when it is deformed. Therefore, by using the piezoelectric device as a detection sensor that detects the difference in the electric voltage generated by the presence and absence of liquid, it is possible to determine the presence of liquid.

A supply port for supplying the liquid to an ejecting head for ejecting the ink may be formed in the liquid storage body. By doing this, it is possible to supply the liquid stored in the liquid storage body as the liquid to be ejected from the ejecting head. In other words, it is possible to use the liquid storage container according to the above-aspect of the present invention as a supply container that supplies liquid to the ejecting head.

According to another aspect of the present invention, there is provided a liquid storage body-receiving member configured as a body separate from a liquid storage body having a liquid storage portion for storing liquid therein, including: a liquid storage body-receiving portion that detachably receives the liquid storage body; and a detection sensor that is used in detecting the liquid within the liquid storage portion when the liquid storage body is attached. When the liquid storage body-receiving member having such a configuration is applied to a liquid storage body having formed therein a detecting portion of which the characteristic varies with the liquid within the liquid storage portion in a manner similar to the case of the liquid storage container, it is possible to provide a liquid storage body-receiving member having substantially the same advantages as that of the liquid storage container according to the prior above-described aspects of the invention.

### BRIEF DESCRIPTION OF THE DRAWINGS

The invention will be described with reference to the accompanying drawings, wherein like numbers reference like elements.

FIG. 1 is a schematic diagram showing the structure of an ink jet printer having an ink cartridge as one embodiment of the present invention.

FIG. 2 is a perspective view schematically showing the overall configuration of an ink cartridge.

FIG. 3 is a sectional view schematically showing an ink container body and a detecting storage body attached to the ink container body.

FIG. 4 is a sectional view schematically showing a first modified example of the ink storage body and the detecting storage body.

FIGS. 5A and 5B are sectional views schematically showing a second modified example of the ink storage body and the detecting storage body.

FIGS. 6A, 6B, and 6C are sectional views schematically showing other modified examples of the ink storage body and the detecting storage body.

### DESCRIPTION OF EXEMPLARY EMBODIMENTS

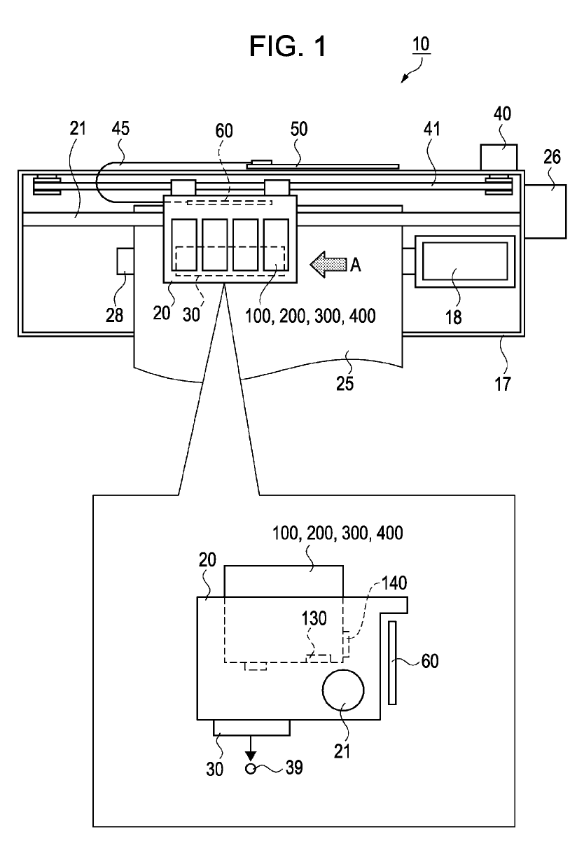

Hereinafter, embodiments of the invention will be described with reference to the accompanying drawings. FIG. 1 shows an overall structure of an ink jet printer 10 as an example of a liquid ejecting apparatus having ink cartridges 100, 200, 300, 400, which are examples of a liquid storage container of the present invention. The ink jet printer 10 is configured such that the ink cartridges 100 to 400 contain colored ink of Y (yellow), M (magenta), C (cyan), and K (black), which is an example of liquid, and are attached to a carriage 20. Ink droplets 39 are ejected from an ejecting head 30 attached at the rear side of the cartridge 20, whereby desired images are printed on a printing sheet 25.

The carriage 20 is fixed to a carriage belt 41 and, as the carriage belt 41 is driven by a carriage motor 40, moves in the left-right direction of the drawing along a guide 21 fixed to a frame 17. At this time, from a plurality of nozzles formed in the ejecting head 30 for ejection of the respective colored inks, a predetermined amount of ink droplets 39 is ejected in correspondence with the production of a printing image. The printing sheet 25 is moved predetermined distances in the up-down direction of the drawing by a sheet conveying roller (not shown), which is driven by a driving motor 26 fixed to the frame 17, while being supported from the rear surface thereof by a platen 28. In this manner, a predetermined amount of ink droplets 39 corresponding to the printing image are ejected with respect to the entire surface of the printing sheet 25, whereby a desired image is formed thereon. Therefore, if ink is not available in the respective ink cartridges 100 to 400, or if the ejection of the ink droplets 39 from the ejecting head 30 is otherwise interrupted, the image forming is not performed properly.

In general, in the ink jet printer 10, at predetermined time intervals, the carriage 20 is moved to the position of a cleaning box 18 to perform a cleaning treatment, wherein bubbles remaining in an ink flow path or a nozzle opening portion formed in the ejecting head 30 are blown out to clean the nozzle.

Such a series of operations are mainly controlled by a main substrate 50 attached to the frame 17 and a sub-substrate 60 attached to the carriage 20. These substrates are connected by a flexible substrate 45 so that necessary data are exchanged between them, whereby a predetermined operation is performed with respect to the ink jet printer 10.

As shown in an enlarged view in the drawing, the ink cartridges 100 to 400 are inserted and detachably fixed to the carriage 20 by a fixing unit (not shown) formed between the carriage 20 and the ink cartridges. The ink supplied from the respective ink cartridges 100 to 400 flows along an ink flow path (not shown) to corresponding nozzles provided to the ejecting head 30. The enlarged view is a sectional view of the carriage 20 as seen in the arrow A direction.

In the respective ink cartridges 100 to 400, a circuit board 140 is attached, having mounted thereon an IC chip that records information about the ink cartridge such as ink consumption information. In the respective ink cartridges 100 to 400, a detection sensor 130 is attached for detection of an ink consumption state within the ink cartridge. Data from the detection sensor 130 is sent to the circuit board 140 via a connection means (not shown), where the data is processed in a predetermined manner and then recorded on the IC chip. For example, when the ink stored in the ink cartridge is completely consumed, the detection sensor detects the absence of the ink, and data corresponding to the detection result is recorded on the IC chip. Then, the recorded data is sent from the circuit board 140 to the sub-substrate 60 by a predetermined communication means (not shown). Then, in accordance with the data of the detection sensor, the printing is appropriately controlled by the sub-substrate and the main substrate 50 as described above. In this way, by being connected to a liquid detection device (in this embodiment, corresponding to the sub-substrate 60 and the main substrate 50) provided to the ink jet printer 10, the detection sensor can function as a part of the liquid detection device.

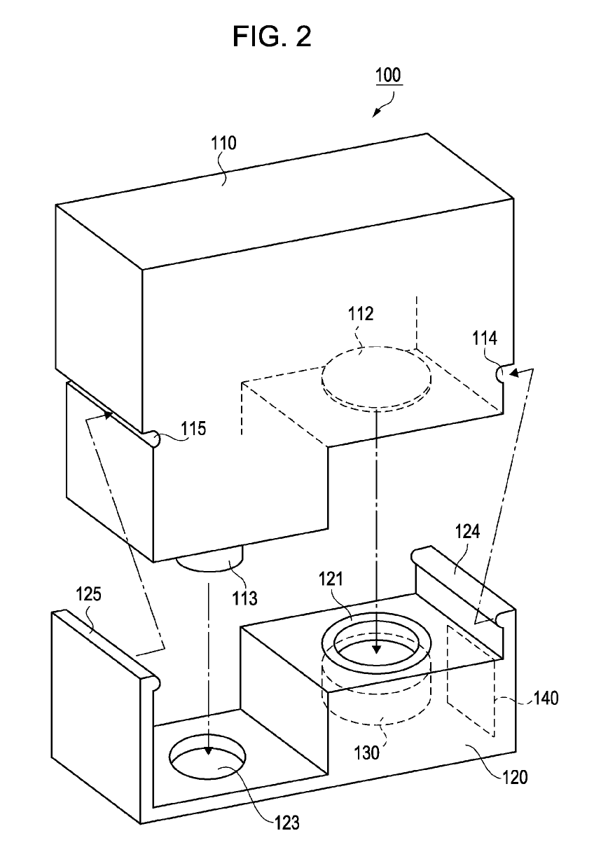

Next, a specific structure of the ink cartridges 100 to 400, which is an embodiment of the liquid storage container of the present invention, will be described with reference to FIG. 2. FIG. 2 is a perspective view schematically showing the overall configuration of the ink cartridge 100. In this embodiment, it is assumed that the respective ink cartridges 100 to 400 have the same structure. In the drawing, the fixing means formed between the carriage 20 and the ink cartridge is not illustrated.

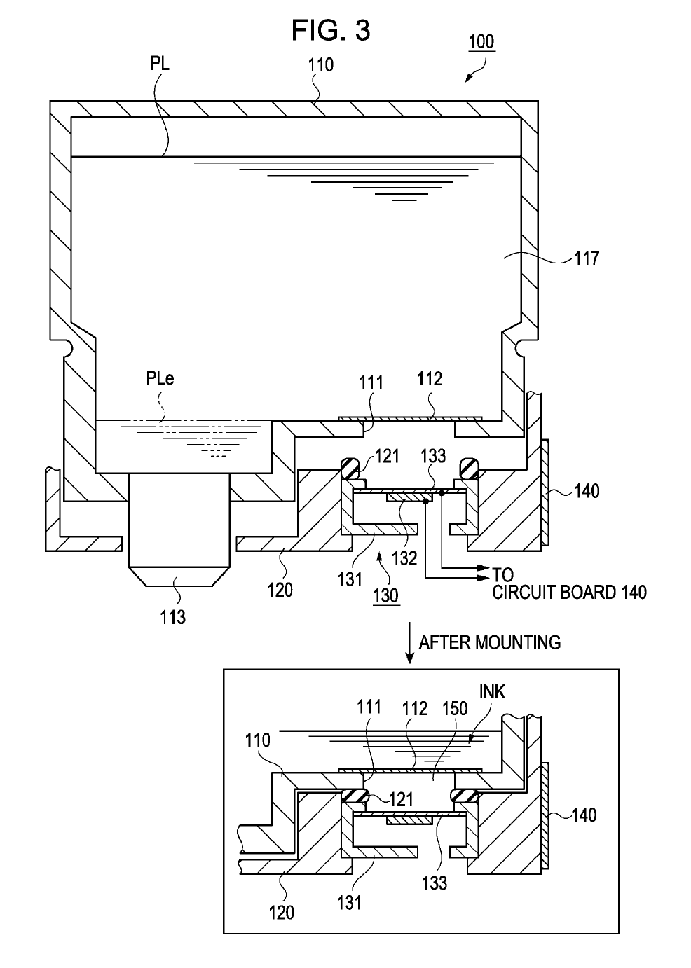

As shown in the drawing, the ink cartridge 100 has a two-body structure with two storage bodies including an ink container body 110 having formed therein a liquid storage portion (FIG. 3: 117) for storing ink and a detection container body 120 for detecting the presence of ink. And, concave portions 114 and 115 formed in the ink container body 110 and convex portions 124 and 125 formed in the detection container body 120 serve as engaging portions. When the detection container body 120 is raised toward the upper part of the drawing, the engaging portions engage with each other, whereby the detection container body 120 is attached to the ink container body 110. In this way, the two storage bodies are combined to form a single ink cartridge 100. Moreover, the ink cartridge is configured with an attachment and detachment structure wherein when the detection container body 120 is pushed down toward the lower part of the drawing, the engagement of the engaging portions is released so that the detection container body 120 is detached from the ink container body 110. When combining the two storage bodies, an outlet port 113 formed in the ink container body 110 passes through a through hole 123 formed in the detection container body 120 so that it does not interfere the combining.

The outlet port 113 formed in the ink container body 110 has a substantially pipe-like shape, wherein an opening portion is formed at a central portion, and functions as an ink supply port for supplying ink to the ejecting head 30. In the opening portion of the outlet port 113, although not shown in the drawing, a valve mechanism is provided. Therefore, when the ink cartridge 100 is not attached to the carriage 20 (FIG. 1), the opening portion is in a closed (sealed) state where the ink will not flow out. On the other hand, when the ink cartridge 100 is attached to the carriage 20, the opening portion is in an open state where the ink stored in the liquid storage portion 117 can flow out from the outlet port 113 and be supplied to the ejecting head 30.

In the ink container body 110, a sheet member 112 having a substantially circular shape is attached. The sheet member 112 is fixed to a substantially circular opening portion (FIG. 3: 111) formed in the ink container body 110 in a sealed state where ink leakage from the outer periphery is prevented. The sheet member 112 is formed in a positional relationship such that the center of the sheet member 112 is substantially coincidental with the center of the detection sensor 130, as denoted by the arrow in the drawing, when the ink container body 110 and the detection container body 120 are attached and combined.

The detection sensor 130 is attached to the detection container body 120, and is configured to output a change in the vibration frequency of a vibration plate having a piezoelectric device bonded thereto using the piezoelectric device. In the detection container body 120, a substantially doughnut-shaped packing member 121 formed of an elastic member and a circuit board 140 are attached.

Next, with reference to FIG. 3, a method of detecting the consumption state of the ink stored in the liquid storage portion 117 in the ink cartridge 100 having such a configuration will be described. FIG. 3 shows in a full sectional view a state immediately before the ink container body 110 and the detection container body 120 are attached and combined is shown in a full sectional view. FIG. 3 also shows in a partial sectional view (inside the rectangular box) some portions of the ink cartridge 100 in a state in which the ink container body 110 and the detection container body 120 are attached and combined.

As shown in FIG. 3, a liquid storage portion 117 for storing ink is formed in the ink container body 110. Also, an opening portion 111 is formed in a portion of a bottom surface of the sidewalls of the ink storage container 110 that constitute the liquid storage portion 117, the bottom surface being in a gravitationally downward direction with respect to the liquid storage body 117. The sheet member 112 is fixed, in a portion of a sidewall surface of the ink storage container 110 close to the liquid storage portion 117 and in the vicinity of the outer periphery of the opening portion 111, by means of welding, adhesion or the like so as to provide a sealed state where ink does not leak from the fixing portion, i.e., from the outer periphery thereof. Therefore, a liquid position level PL of the ink falls in accordance with the amount of ink let out from the outlet port 113 and eventually reaches close to a liquid level position PLe of the ink denoted by the dashed-two dotted line in the drawing, and until this level PLe is reached, the ink stored in the liquid storage portion 117 maintains an abutting state with respect to the sheet member 112 without leaking through the sheet member 112.

The detection sensor 130 is constructed by a vibration plate 133 of which the circumference is fixed to the inner vertex surface of a case body 131 and a piezoelectric device 132 bonded to the vibration plate 133. When the vibration plate 133 freely vibrates, the piezoelectric device 132 generates an electric voltage by the electrostriction effect and outputs the generated electric voltage, from electrodes (not shown) formed on both surfaces of the piezoelectric device, to the circuit board 140 via a connection member (not shown). As a concrete example in this embodiment, the detection sensor 130 may be a detection sensor having the structure disclosed in JP-A-2001-328280 described above.

The packing member 121 is fixed by means of adhesion or the like to the upper surface of the detection sensor 130 and maintains a non-compressed state when the two storage bodies of the ink container body 110 and the detection container body 120 are not attached and combined.

When the ink container body 110 and the detection container body 120 are combined, as shown in the drawing, the packing member 121 is deformed so as to make pressure contact with the ink container body 110. As a result, a space 150, which is formed by the sheet member 112, the opening portion 111, the packing member 121, the case body 131, and the vibration plate 133, forms a closed space, and the vibration plate 133 and the sheet member 112 are disposed in a state such that the air confined in this space 150 acts as an air spring; the respective vibration of the vibration plate 133 is coupled with the vibration of the sheet member 112 (this is referred to as a vibration coupling). Therefore, when the vibration plate 133 vibrates, the sheet member 112 also vibrates, via the air spring.

When the sheet member 112 vibrates as a vibration plate, a vibration impedance (this is referred to as a radiation impedance) varies depending on whether ink is or is not abutting on the sheet member 112, whereby a natural vibration frequency of the sheet member 112 varies. As a result, the change in the natural vibration frequency of the sheet member 112 gives rise to a change in the radiation impedance when the vibration plate 133 principally vibrates, whereby the natural vibration frequency of the vibration plate 133 is varied. Then, the electric voltage of the piezoelectric device 132 generated by the vibration of the vibration plate 133 is extracted from the electrodes (not shown) formed on both surfaces of the piezoelectric device 132 and is output to the circuit board 140. Since the output electric voltage varies with the change in the natural vibration frequency of the vibration plate 133, when the circuit board 140 detects the change in the electric voltage, the presence of ink is detected.

In this way, according to the ink cartridge 100 of the present embodiment, the ink container body 110 and the detection container body 120 are attached and combined, and the change in the vibration frequency that is included in the electric voltage output from the detection sensor 130 is detected, whereby the ink consumption state is detected. That is, the natural vibration frequency of the vibration plate 133 varies from a vibration frequency when ink is left in the liquid storage portion 117 and thus abuts on the sheet member 112 to a vibration frequency when the ink stored in the liquid storage portion 117 is consumed and thus does not abut on the sheet member 112. When the detection sensor 130 extracts the change in the vibration frequency as a change in the electric voltage and output the change in the electric voltage to the circuit board 140, it is possible to detect that the ink has been consumed to the level where the liquid level of the ink is at level PLe.

When the liquid level position PLe of the ink represents an ink-end state, as described above, a printing operation is appropriately controlled (stopped, for example) by the sub-substrate 60 and the main substrate 50. The ink cartridge 100 in the ink-end state is detached from the carriage 20 and then the detection container body 120 is detached from the ink container body 110. The detached detection container body 120 is attached to another ink container body 110 which is filled with ink. By doing this, it is possible to replace with an ink cartridge filled with ink and equipped with a detection sensor capable of detecting the ink end state. Thereafter, when the thus-obtained ink cartridge is attached to the carriage 20, it is possible to resume the printing operation. In this manner, by detaching the detection container body 120 from the ink container body 110, it is possible to detach the detection sensor 130 from the ink cartridge 100. Therefore, it is not necessary to detach the detection sensor 130 from the detection container body 120, thereby simplifying the detection sensor detaching operation, which was a problem of the related art.

In some cases, when the detection sensor 130 has detected the ink-end state, due to a detection error of the detection sensor 130, the ink stored in the liquid storage portion 117 is abutting on the sheet member 112. In such a case, even when the detection container body 120 is detached from the ink container body 110, since the opening portion 111 is in a sealed state where ink does not leak because of the sheet member 112 as described above, the ink does not leak from the ink container body 110.

Since the opening portion 111 formed in the ink container body 110 is sealed by the sheet member, ink does not leak from the ink container body 110 even when the liquid storage portion 117 is filled with ink. Therefore, even after the ink container body 110 is filled with ink, it is possible to attach the detection sensor 130 by attaching the detection container body 120.

In this way, according to the present embodiment, the ink cartridge 100 is configured to have a two storage body structure, the two bodies being the ink container body 110 in which ink is stored and the detection container body 120 in which the detection sensor 130 is attached and these storage bodies are detachable from each other. Therefore, it is possible to attach or detach the detection sensor 130 that detects the ink consumption state (such as an ink end state) to or from the ink cartridge 100 while preventing ink leakage from the ink container body 110. In the present embodiment, the ink container body 110 is the liquid storage body and the detection container body 120 is the liquid storage body-receiving member.

Hereinabove, although the exemplary embodiments of the invention have been described with reference to the accompanying drawings, it should be understood that the invention is not limited to such embodiments but various changes may be made without departing from the spirit or scope of the invention. Some other examples of how to achieve concrete embodiments in accordance with the principles of the invention will now be described below.

### First Modified Example

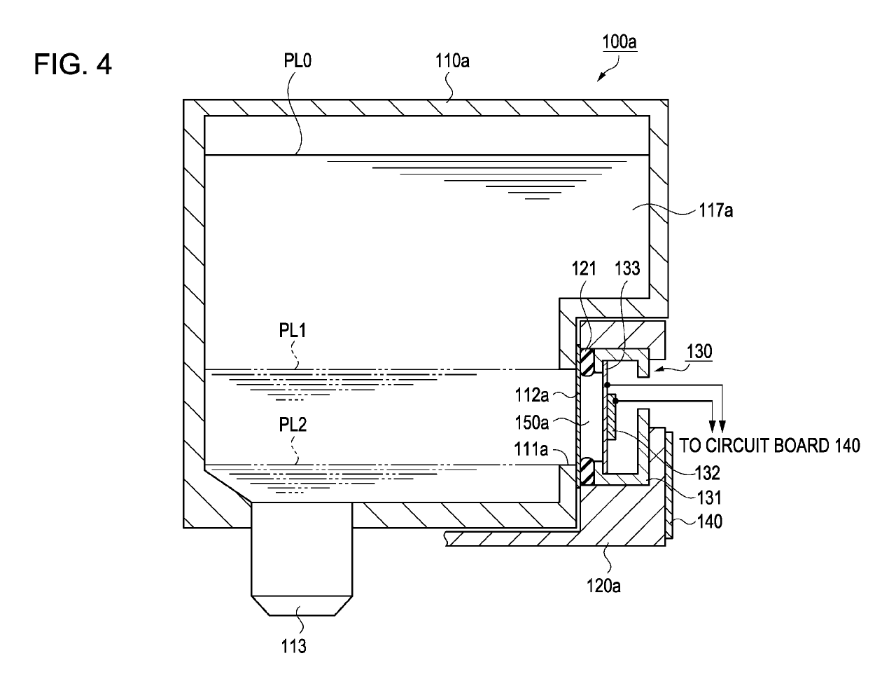

In the embodiment described above, as shown in FIG. 3, the sheet member 112 is fixed to the bottom sidewall which is in the gravitational direction with respect to the ink container body 110, and the ink is abutting on the sheet member 112 in the direction (gravitational direction) from the upper side to the lower side in the drawing. However, the ink cartridge may have a different configuration. For example, as shown in FIG. 4, an ink cartridge 100a is configured such that an ink container body 110a is attached to a detection container body 120a in the horizontal direction of the drawing (a direction substantially perpendicular to the gravitational direction).

In this modified example, in the ink container body 110a, an opening portion 111a is formed in a sidewall of the liquid storage portion 117a, the sidewall being in the direction substantially perpendicular to the gravitational direction. In the opening portion 111a, a sheet member 112a of which the outer periphery is fixed in a sealed state is attached. Unlike the embodiment described above, in this modified example, the sheet member 112a is fixed to a sidewall surface (i.e., an outer wall surface) of the sidewalls of the ink container body 110a, the sidewall surface being opposite the liquid storage portion 117a. That is to say, the sheet member 112a is on a lateral face of the ink cartridge instead of a lower face.

According to the ink cartridge 100a having such a configuration, when ink is supplied from the outlet port 113 to the ejecting head 30 so that the ink stored in the liquid storage portion 117a is consumed, the liquid level position of the ink gradually falls from a liquid level position PL0 which corresponds to an ink-full state. When the liquid level falls lower than the upper end of the opening portion 111a, i.e., position PL1 (denoted by the dashed-two dotted line in the drawing) where the ink is abutting on the entire surface of the sheet member 112a, the area of the sheet member 112a abutting the ink decreases with the falling of the liquid level position of the ink. As a result, as described above, until the liquid level position of the ink reaches the lower end of the opening portion 111a, i.e., a liquid level position PL2 where the ink is not abutting on the sheet member 112a, the radiation impedance when the sheet member 112a vibrates varies with the falling of the liquid level position of the ink.

In this way, since the radiation impedance of the sheet member 112a varies with the liquid level position of the ink, as described above, the natural vibration frequency of the vibration plate 133 changes with the liquid level position of the ink. Then, when the piezoelectric device 132 transforms the change in the natural vibration frequency of the vibration plate 133 into a change in an electric voltage and outputs the transformed change in the electric voltage to the circuit board 140, it is possible to detect the change in the natural vibration frequency of the vibration plate 133. By empirical investigation or the like, the relationship between the liquid level position of the ink and the natural vibration frequency of the vibration plate 133 can be determined. It is therefore possible to approximate the liquid level position of the ink from the actual natural vibration frequency of the vibration plate 133, when the liquid level position of the ink in the liquid storage portion 117a is between the liquid level position PL1 and the liquid level position PL2. Therefore, it is possible to detect the ink consumption state by the change in the natural vibration frequency of the vibration plate 133. Accordingly, it is possible to prevent a misjudgment with respect to the presence of the ink and to properly detect the ink consumption state or the ink end state.

A space 150a, formed when the ink container body 110a and the detection container body 120a are combined, can have a small volume smaller than the space 150 (FIG. 3) of the above-described embodiment since the fixing position of the sheet member 112a is on the outer wall surface not on the inner wall surface. That is, though the space 150 includes the opening portion 111, the space 150a does not include the opening portion 111a and is formed by the sheet member 112a, the packing member 121, the case body 131, and the vibration plate 133. That is to say, the sheet member 112a is not on the inside of the opening 111a, but the outside, and so the space between sheet member 112a and vibration plate 133 is reduced. Therefore, since the space 150a has a small volume smaller than the space 150, the air confined in the space 150a can have a large compression ratio with respect to the amount of bending of the vibration plate 133, whereby the vibration of the vibration plate 133 can be securely transmitted to the sheet member 112a. As a result, the change in the natural vibration frequency of the vibration plate 112a can be securely transmitted to the vibration plate 133. Accordingly, the change in the natural vibration frequency of the vibration plate 133 is advantageously amplified.

In FIG. 4, although the attachment and detachment structure of the ink container body 110a and the detection container body 120a is not particularly described, they may be engaged with each other by a concave and convex shape formed in each storage body in the manner shown, e.g., in FIG. 1. For example, one of the two storage containers may serve as an outer case and the other storage container may serve as an inner case so that the two cases can be detachably attached to each other. Additionally or alternatively, a fastening means such as one that threadably attaches the two storage containers to each other may be used in the attachment and detachment structure. These attachment and detachment structures are similarly applicable to the embodiment described. As long as an attachment and detachment structure has a shape that allows easy attachment and detachment of two storage bodies, an arbitrary attachment and detachment structure can be used.

### Second Modified Example

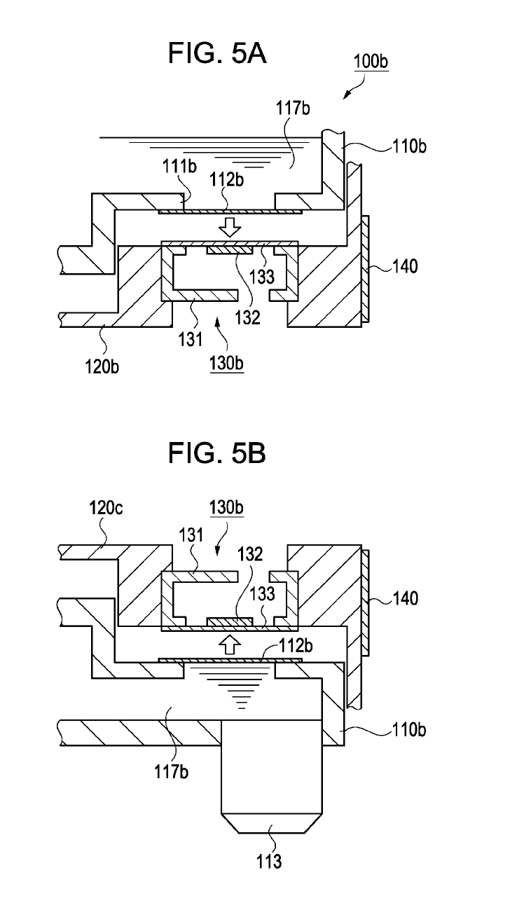

In the embodiment described above, the vibration of the vibration plate 133 of the detection sensor 130 and the vibration of the sheet member 112 are coupled via the air spring that uses the air confined in the space 150. Although an air spring may be used to great advantage, the use of an air spring can be omitted in favor of a direct coupling arrangement; the vibration of the vibration plate 133 and the vibration of the sheet member 112 may be directly coupled without the air spring. This modified example will be described with reference to FIGS. 5A and 5B.

FIG. 5A is a sectional view showing some parts of an ink cartridge 100b according to this modified example. According to the ink cartridge of the present modified example, like the above-described embodiment shown in FIG. 3, has a two-body structure in which an ink container body 110b is attached to a detection container body 120b from the upper part of the drawing.

Like the embodiment described above, in this modified example, in the ink container body 110b, an opening portion 111b is formed in a portion of a bottom surface of the sidewalls constituting a liquid storage portion 117b, the bottom surface being in the gravitational direction with respect to the liquid storage portion 117b. In the opening portion 111b, a sheet member 112b of which the outer periphery is fixed in a sealed state is attached. Unlike the embodiment described above, in this modified example, the sheet member 112b is fixed to a sidewall surface (i.e., an outer wall surface) of the sidewalls of the ink container body 110b, the sidewall surface being opposite the liquid storage portion 117b. A detection sensor 130b is attached to the detection container body 120b. As shown in the drawing, unlike the embodiment described above, the detection sensor 130b is fixed to the outer vertex surface of the case body 131 by the vibration plate 133 of which the circumference is bonded by welding or adhesion to the outer vertex surface.

In the ink cartridge 100b of the modified example having such a configuration, when the ink container body 110b and the detection container body 120b are combined, the sheet member 112b is moved as denoted by the hollow arrow in the drawing and comes into contact with the vibration plate 133. As a result, the sheet member 112b and the vibration plate 133 function in principle as a single vibration plate. When the sheet member 112b is formed such that the sheet member 112b is greatly deformable in the gravitational direction by the weight of the ink stored in the ink storage portion 117b, substantially the entire area of the sheet member 112b corresponding to the opening portion 111b are abutting on the vibration plate 133. It is possible to attain an effect such that the sheet member 112b and the vibration plate 133 function as substantially one vibration plate. The sheet member 112b may be formed of a material having an autohesion property so that the vibration plate 133 adheres to the sheet member 112b.

When the sheet member 112b and the vibration plate 133 abut each other and vibrate as a single vibration plate, as described above, since the radiation impedance when the single vibration plate vibrates depending on whether ink is abutting on or not varies, whereby the natural vibration frequency of the single vibration plate is varied. Then, the electric voltage of the piezoelectric device 132 generated by the vibration of the vibration plate 133 is extracted from the electrodes (not shown) formed on both surfaces of the piezoelectric device 132 and is output to the circuit board 140. Since the output electric voltage varies with the change in the natural vibration frequency of the single vibration plate, when the circuit board 140 detects the change in the electric voltage, the presence of ink in the liquid storage portion 117b is detected.

In this modified example, as shown in FIG. 5A, in a portion of the liquid storage portion 117b in which the opening portion 111b is formed, a case may be anticipated in which ink will not flow out by its own weight and remains there. In such a case, since the radiation impedance by the remaining ink can appear to be the same as the radiation impedance when the ink is present, there may be concern that the detection sensor 130b could mistakenly judge that ink is present in the ink container body 110b when actually an ink end state should be judged.

Therefore, when practicing this modified example, as shown in FIG. 5B, it may be configured such that when the ink container body 110b and the detection container body 120c are combined, the sheet member 112b is moved as denoted by the arrow in the drawing and makes contact with the vibration plate 133. That is, the attachment direction of the detection sensor 130b is reversed so that the up-down relationship is opposite to that of FIG. 5A, whereby the ink is abutting on the vibration plate 133 from the downside of the drawing to the upside (i.e., counter-gravitational direction). By doing this, when the ink has flowed out from the outlet port 113 so that the amount of the ink in the liquid storage portion 117b starts decreasing, the ink will by its own weight move away from a vibrating surface of the sheet member 112b. Therefore, it is possible to attain an effect that the natural vibration frequency of the one vibration plate is securely varied with the decrease in the amount of the ink in the liquid storage portion 117b. As a result, it is possible to prevent a misjudgment on the presence of ink due to the own weight of the ink and possible to properly detect the ink consumption state.

### Other Modified Examples

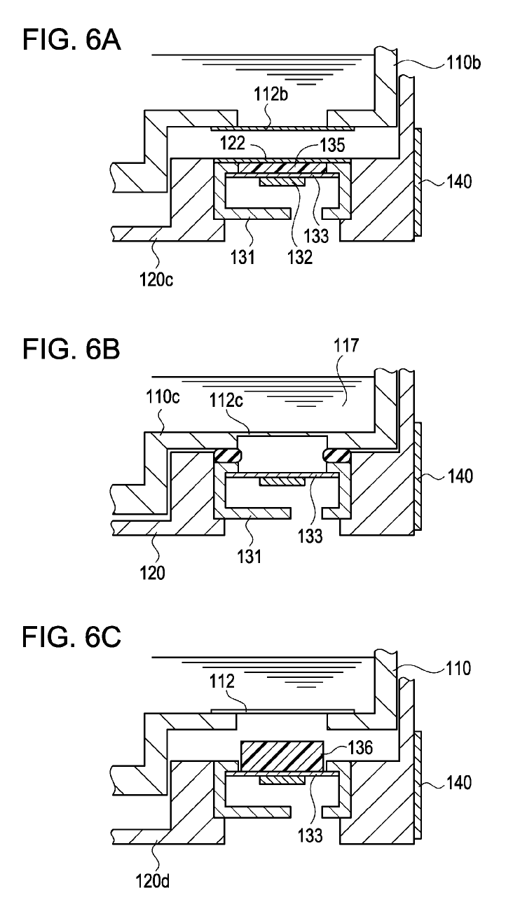

In the second modified example, the sheet member 112b and the vibration plate 133 are directly coupled with via the air spring. However, since the vibration plate 133 is practically formed of a very thin metal plate, the vibration plate 133 may be more susceptible to damage than is desirable in a consumer product. For this reason, when the vibration plate 133 is formed on the outer surface of a case body, the vibration plate 133 can be said to have a high risk of damage. Therefore, as shown in FIG. 6A, a sheet member 122 may be bonded to the outer vertex surface of the case body 131 so that the sheet member 122 other than the vibration plate 133 abuts on the sheet member 112b. The result is that, since the vibration plate 133 is not directly exposed to the outside, it is possible to prevent the vibration plate 133 from being damaged.

Here, though it is necessary to couple the vibration of the vibration plate 133 with the vibration of the sheet member 122, in this modified example, as shown in FIG. 6A, a spacer 135 may be disposed between them so that the vibration coupling is made via the spacer 135. The spacer 135 is preferably formed of an elastic member so that the spacer 135 is compressed a predetermined amount when it is inserted between the vibration plate 133 and the sheet member 122. By doing this, an elastic force is securely generated between the vibration plate 133 and the sheet member 122, whereby a stable vibration coupling is provided. Moreover, instead of inserting the spacer 135, the vibration coupling by the air spring may be used as described above.

In the embodiment described above, a thin plate-like sheet member 112 is bonded to the ink container body 110. However, as shown in FIG. 6B, a thin wall portion 112c may be formed in an ink container body 110c by making a sidewall of the ink container body 110c thin, and the thin wall portion 112c may be used as a vibration plate having the same function as the sheet member 112. For example, when the ink container body 110 is formed by an injection molding of a plastic material, the thin wall portion 112c can be formed from an injection mold. In this way, it is possible to eliminate a separate operation of fixing the sheet member 112 to the ink container body 110, thereby decreasing the working load. Since the sealed portion is not used, there is no risk that the formation of a poor seal could result in a leak. The forming position of the thin wall portion 112c is not limited to the inner wall position of the liquid storage portion 117, as shown in FIG. 6B, but it may be formed at an outer wall position or a position intermediate with respect to such positions.

In the embodiment described above, the vibration coupling between the sheet member 112 and the vibration plate 133 is performed via the air spring. However, as shown in FIG. 6C, the vibration coupling may be made via a spacer 136. In FIG. 3, the volume of the confined space 150 is large compared with the vibration amplitude of the vibration plate 133. In such a case, it may be possible that the force of the air spring is too weak to vibrate the sheet member 112. Therefore, by using the spacer 136, the vibration of the vibration plate 133 is securely transmitted to the sheet member 112. The spacer 136 is preferably formed of an elastic member so that the spacer 136 is compressed by at least a predetermined amount when the ink container body 110 and the detection container body 120d are combined. By doing this, an elastic force is securely generated between the vibration plate 133 and the sheet member 112, whereby a stable vibration coupling is provided.

In the embodiment and the modified examples described above, it has been described that one detection container body 120 is attached to one ink container body 110. However, the invention is not particularly limited to this. For example, two detection container bodies may be detachably attached to one ink container body. By doing this, it is possible to detect the ink consumption amount in two stages. Needless to say, two or more detection container bodies may be detachably attached to one ink container body.

In the embodiment described above, as shown in FIG. 3, it has been described that by using the piezoelectric device 132 as the detection sensor 130 and detecting the vibration frequency (natural vibration frequency) of the vibration plate 133, the presence of the ink is detected. However, the invention is not limited to this. For example, a characteristic that varies depending on the presence of ink may be detected by detecting a difference in the voltage magnitude of the electric voltage (back electromotive force) generated in a piezoelectric device resulting from a difference in the vibration amplitude of a vibration plate as described in JP-A-2001-328280, or detecting a difference in a propagation speed of a wave propagating through a medium.

In the embodiment described above, it has been described that the change in the vibration frequency of the vibration plate 133 is detected by the detection sensor 130 using a piezoelectric device. However, a detection sensor that does not use the piezoelectric device may be used. For example, an optical sensor that detects an optical change induced by the presence or absence of ink may be used by forming the sheet member 112 using an optically transparent material so that the change in the density of a color induced by the differing amount of ink is detected, or the light heading from a light emitting portion toward a light receiving portion is blocked or weakened. In such a case, the optical change may be transformed into a change of an electric voltage (current) by a light receiving device and output to the circuit board 140.

In the embodiment described above, the ink for forming images on a printing sheet was described as an example of liquid. However, the liquid is not limited to ink. For example, the liquid may be a recording fluid or a functional fluid for forming images on a glass substrate or a resin substrate to form a constituent element of a liquid crystal panel or an organic EL panel.

What is claimed is:

1. A liquid storage container configured to be detachable from a liquid ejecting apparatus, the liquid storage container comprising:
a liquid storage body having a liquid storage portion for storing liquid therein; and
a liquid storage body-receiving member configured as a body separate from the liquid storage body and detachably receiving the liquid storage body;
wherein the liquid storage body-receiving member comprises a detection sensor for use in detecting the liquid within the liquid storage body.

2. The liquid storage container according to claim 1, wherein:
the liquid storage body comprises a detecting portion having a characteristic that varies with the amount of the liquid within the liquid storage body; and
the detection sensor is able to detect a change in the characteristic of the detecting portion.

3. The liquid storage container according to claim 2, wherein the characteristic is a vibration frequency.

4. The liquid storage container according to claim 2, wherein the characteristic is a vibration amplitude of a vibration plate.

5. The liquid storage container according to claim 2, wherein the detection sensor comprises a piezoelectric device.

6. The liquid storage container according to claim 1, wherein:
the liquid is ink; and
the liquid storage body comprises a supply port for supplying the ink to an ejecting head for ejecting the ink.

7. A liquid storage body-receiving member, comprising:
a liquid storage body-receiving portion that detachably receives a liquid storage body; and
a detection sensor for use in detecting the liquid within the liquid storage body when the liquid storage body-receiving portion has received the liquid storage body.
